(19) United States
(12) Patent Application Publication
(10) Pub. No.: US 2026/0257133 A1
(43) Pub. Date: Sep. 3, 2026

(54) AI-DRIVEN VIDEO GAME TRAINING AND ASSISTANCE

(71) Applicant: SONY INTERACTIVE ENTERTAINMENT INC., Tokyo (JP)

(72) Inventors: Alex Song, Palo Alto, CA (US); Daniel Hiatt, San Francisco, CA (US); Mayu Watanabe, Los Angeles, CA (US); Chris Thielbar, El Cerrito, CA (US)

(21) Appl. No.: 19/069,100

(22) Filed: Mar. 3, 2025

(51) Int. Cl. A63F 13/533; A63F 13/497; A63F 13/67; A63F 13/79

(52) U.S. Cl. CPC A63F 13/533; A63F 13/497; A63F 13/67; A63F 13/79

(57) ABSTRACT

Techniques for improving a user video game experience are described. In an example, a computer system may access game data for a video game. The game data may include video depicting game play of a user of the video game against a target opponent of the video game. The computer system may further access a video game signal associated with a video game controller that is used by the user to play the video game and that is generated during the game play. The computing system may then generate, using an AI model and based on the game data and the video game signal, evaluation data for the game play. Additionally, the computing system may generate, based on the evaluation data, at least one of an instruction for controlling the video game controller and a minigame for facilitating a practice match against the target opponent.

### BACKGROUND

Video games are available on different computing devices. For example, a user operates a video game console and a mobile device to play a first video game and a second video game, respectively. In addition, video games are available from different sources. For example, the video game console is operable to play multiple video games from two or more different video game developers.

Given the increasing number of video games and their availability on different computing devices and from different sources, the user experience typically changes. For example, the way game play help may be sought can vary significantly between video games. In addition, the way a particular part of a video game is surfaced on a computing device as being available for playing can be unique to the particular video game.

Hence, the user experience may not be common between the video game players. There is a need for improving the user experience such that, regardless of the underlying video games, some commonality in video game functionalities becomes possible.

### BRIEF SUMMARY

Techniques for improving a user video game experience are described. In some embodiments, a method implemented by a computer system is provided. The method may include accessing game data for a video game, the game data comprising video depicting game play of a user of the video game against a target opponent of the video game; accessing at least one video game signal associated with at least one device that is used by the user to play the video game and that is generated during the game play, the at least one device comprising a video game controller; generating, using an AI model and based on the game data and the at least one video game signal, evaluation data for the game play; and generating, based on the evaluation data, at least one of an instruction for controlling the video game controller and a minigame for facilitating a practice match against the target opponent.

In some embodiments, the at least one video game signal comprises one or more of: a set of controller inputs, settings of the video game controller that were used by the user during the game play, and settings of the video game during the game play.

The method may further include, generating, based on the evaluation data, the instruction for controlling the video game controller, wherein the instruction comprises at least one of an alternative controller input, an alternative setting of the video game controller, and an alternative setting of the video game.

In some embodiments, the at least one device further comprises a video game console and a display device, and the method further comprises: generating, based on the evaluation data, the instruction for controlling the video game controller; and transmitting the instruction for controlling the video game controller to the video game console to cause the video game console to output the instruction for controlling the video game controller via the display device, wherein the instruction for controlling the video game controller is output during game play of the user against target opponent, and wherein the instruction for controller the video game controller comprises an aural instruction signal or a visual instruction signal.

The method may further include generating, based on the evaluation data, the instruction for controlling the video game controller; and generating a review video of the game play of the user against the target opponent, the review video comprising the video depicting the game play and the instruction for controlling the video game controller.

In some embodiments, the at least one device further comprises a video game console, and the method further comprises: generating, by inputting the evaluation data into a second AI model, the minigame for facilitating the practice match against the target opponent, the second AI model being a generative AI model; and transmitting the minigame for facilitating the practice match against the target opponent to the video game console to enable a game play of the user of the minigame.

In some embodiments, the game data for the video game is first game data, the video depicting the game play of the user of the video game is a first video, and the instruction for controlling the video game controller is a first instruction. Additionally, the method may further include accessing second game data comprising a second video depicting the game play of the user of the minigame; accessing at least one additional video game signal associated with at least one device that is used by the user to play the minigame and that is generated during the second game play; generating, by inputting the at least one additional video game signal and the second game data into the AI model, evaluation data for the game play of the user of the minigame; and generating, based on the evaluation data for the game play of the user of the minigame, at least one of a second instruction signal for controlling the video game controller and a minigame for facilitating an additional practice match against the target opponent.

The method may further include, prior to generating the evaluation data, receiving, from the at least one device, a request for the instruction for controlling the video game controller, the request comprising an indication of the target opponent.

In some embodiments, a computer system is provided. The computer system may comprise one or more processors and one or more memories storing computer-readable instructions. Upon execution by the one or more processors, the computer-readable instructions may configure the computer system to perform operations comprising accessing game data for a video game, the game data comprising video depicting game play of a user of the video game against a target opponent of the video game; accessing at least one video game signal associated with at least one device that is used by the user to play the video game and that is generated during the game play, the at least one device comprising a video game controller; generating, using an AI model and based on the game data and the at least one video game signal, evaluation data for the game play; and generating, based on the evaluation data, at least one of an instruction for controlling the video game controller and a minigame for facilitating a practice match against the target opponent.

In some embodiments, one or more non-transitory computer-readable media are provided. The computer-readable media may store computer-readable instructions that, upon execution on a computer system, cause the computer system to perform operations comprising accessing game data for a video game, the game data comprising video depicting game play of a user of the video game against a target opponent of the video game; accessing at least one video game signal associated with at least one device that is used by the user to play the video game and that is generated during the game play, the at least one device comprising a video game controller; generating, using an AI model and based on the game data and the at least one video game signal, evaluation data for the game play; and generating, based on the evaluation data, at least one of an instruction for controlling the video game controller and a minigame for facilitating a practice match against the target opponent.

### BRIEF DESCRIPTION OF THE DRAWINGS

FIG. 1 illustrates an example of a computing environment for collecting and processing game data and video game signals, according to embodiments of the present disclosure.

FIG. 2 illustrates an example of a system architecture for providing contextual information related to a video game, according to embodiments of the present disclosure.

FIG. 3 illustrates an example of a system for generating instructions related to a video game, according to embodiments of the present disclosure.

FIG. 4 illustrates an example of a system for generating a minigame related to a video game, according to embodiments of the present disclosure.

FIG. 5 illustrates an example of a system for executing an AI agent in a video game, according to embodiments of the present disclosure.

FIG. 6 is a flow chart of an example of a method for generating at least one of an instruction and a minigame related to a video game, according to embodiments of the present disclosure.

FIG. 7 is a flow chart of an example of a method for executing an AI agent in a video game, according to embodiments of the present disclosure.

FIG. 8 illustrates an example of a hardware system suitable for implementing a computer system, according to embodiments of the present disclosure.

### DETAILED DESCRIPTION

Generally, systems and methods for improving a video game functionality are described In an example, the video game functionality is improved by providing a unified way for, among other things, providing instructions during gameplay, such as by suggesting controller inputs and presenting video game help, regardless of the underlying video games. This unified way need not change how a video game is developed or necessitate a common approach to video game development. Instead, analysis of various events in the video games is relied upon, where a player evaluation platform (e.g., a server-based video game service) can collect and process data related to such events based on the execution of the video games to provide instructions. In addition or alternative to instructions, the player evaluation platform can automatically generate minigames to facilitate practice of skills or activities related to video games. Moreover, the player evaluation platform may execute an AI agent to play alongside a user in a video game.

Embodiments of the present disclosure provide many technical advantages over existing video game platforms. In particular, the user interface (e.g., GUI) is improved relative to existing user interfaces because relevant instructions, minigames, or AI agents can be presented therein in a common manner across different applications and different computing devices. For instance, by analyzing events per activity, video game, and video game player, a player evaluation platform of the present disclosure can accurately determine instructions to improve a user's success in a video game. Because an accurate determination can be performed, multiple video game functionalities become possible. In particular, a relevant instruction, minigame, or AI agent can be presented on the user interface in a manner common to different types of computing devices (e.g., the same information can be surfaced on a video game console and on a mobile device). Hence, different relevant instructions and minigames can be suggested in a common manner across the video games and computing devices.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

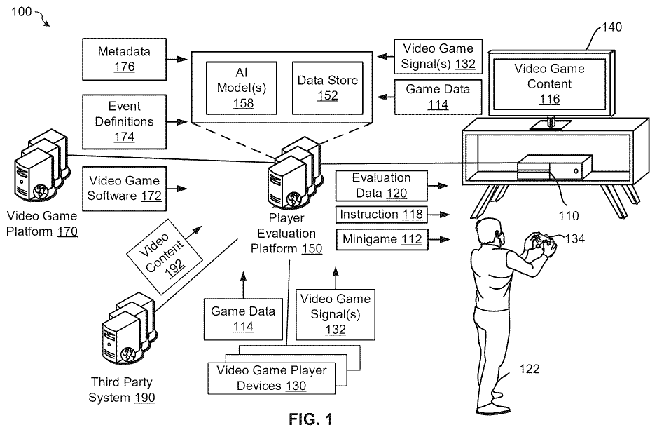

FIG. 1 illustrates an example of a computing environment 100 for collecting and processing game data and video game signals, according to embodiments of the present disclosure. As illustrated, the computing environment 100 includes a video game console 110, video game player devices 130, a player evaluation platform 150, a video game platform 170, and a third-party system 190. Video games may be available to the video game console 110 from the video game platform 170. The player evaluation platform 150 may collect, store, and process events from the video game player devices 130, the video game platform 170, and the third-party system 190 to provide video game-related data (e.g., evaluation data 120) in a unified way for each video game.

In an example, the video game console 110 represents a computing device available to a user 122 and operable to interact with one or more applications including video games. A display device 140 communicatively coupled or integrated with the video game console 110 can present video game-related data, including video game content 116, to the user 122. Other types of computing devices can be available to the user 122 including for instance, a smartphone, a tablet, a laptop, a desktop computer, or other devices with suitable memories and processors.

The video game console 110 can execute a video game locally to present the video game content 116 on the display device 140. Additionally, or alternatively, the video game consoles 110 can receive the video game content 116 based on an execution of an instance of the video game application on the video game platform 170 or another remote computer system. The video game can also be downloadable to the video game console 110 from such systems.

Further, the video game console 110 can, directly or through the video game platform 170, download or stream content (e.g., instruction 118 or minigame 112) from the player evaluation platform 150 for presentation on the display device 140. For example, the video game console 110 may receive the instruction 118 from the player evaluation platform 150. The instruction 118 may then be displayed on the display device 140. The instruction 118 may provide the user 122 with advice for game play of a video game. For example, the instruction 118 may provide advice on how to beat a target opponent (e.g., a boss). Alternatively, the video game console 110 may receive the minigame 112 from the player evaluation platform 150. Content of the minigame 112 may then be displayed on the display device 140 and the user 122 may play the minigame. The minigame 112 may be generated by the player evaluation platform 150 to enable the user 122 to practice an aspect of the video game. For example, the minigame 112 may be a practice match against an opponent similar to the target opponent, thereby enabling the user to practice and prepare for a subsequent game play against the target opponent.

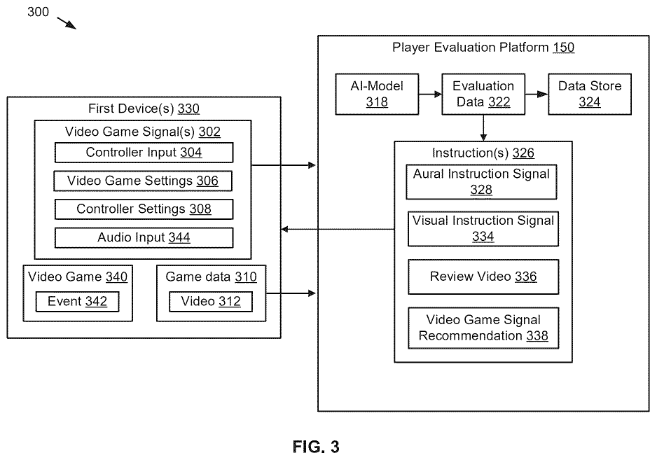

The player evaluation platform 150 may generate the instruction 118, the minigame 112, or other content using one or more artificially intelligent (AI) models 158. For example, video game signals 132 from the video game player devices 130 (e.g., video game controller 134), the video game console 110, the display device 140, or a combination thereof can be input to an AI model 158. Game data 114 (e.g., video, audio, or text data from the video game) can also be input to the AI model 158. As a result, the AI model 158 may generate evaluation data 120 that may score or otherwise provide evaluation statistics for game play of the video game by the user 122. The player evaluation platform 150 may then generate the instruction 118, the minigame 112, or a combination thereof based at least in part on the evaluation data 120. The generation of instructions, minigames, evaluation data, or other suitable data or video game content by the player evaluation platform 150 is described in further detail below with respect to FIGS. 3-8.

In an example, the video game player devices 130 represent computing devices of video game players that may, but need not, include the user 122. The video game controller 134 is one example of a video game player device. Similar functionalities can be provided on each one of the video game player devices and the video game console 110.

In an example, the video game platform 170 represents a computer system that includes a set of computing resources for developing, deploying, or a combination thereof, video games. In particular, the video game platform 170 can store video game software 172, upload such software 172 to the player evaluation platform 150, and/or download such software 172 to the video game console 110.

The video game software 172 of a video game is program code executable to present and interact with video game content of the video game. The program code can include predefined instrumentations to generate events upon the execution of the program code. In particular, the program code includes a set of event definitions 174, where an event definition represents code defining an identifier of an event and data to be reported for the event. Examples of such event definitions 174 are further described herein below and are predefined in the program code of the video game according to event templates available from the video game platform 170. Such event templates can be defined by a service provider of the video game platform 170.

In an example, the third-party system 190 represents a computer system, such as one or more content servers, for providing video content 192 to the video game console 110 directly or indirectly through the player evaluation platform 150 or the video game platform 170. The video content 192 can include video files demonstrating how a video game can be played, how a set of activities in the video game can be played, how an event in a video game has been played by another player, or the like. The video content 192 can be uploaded to the third-party system 190 from the video game platform 170, the video game console 110, and/or one or more of the video game player devices 130 directly or indirectly. The video content 192 can further be stored by the player evaluation platform 150 (e.g., in data store 152) and/or used by the player evaluation platform 150 to generate content (e.g., the instructions 118 and minigame 112).

Additionally, in an example, the video game platform 170 represents a computer system that provides various video-game related functionalities to the video game console 110. For instance, the video game platform 170 may be communicatively coupled with the video game console 110, the video game player devices 130, the player evaluation platform 150, and third-party system 190. In particular, the video game software 172 and the video content 192 can be downloaded to the video game console 110 through the video game platform 170. An instance of a video game based on video game software stored on the video game platform 170 can be instantiated for the video game console 110. A video file can be streamed through the video game platform 170 to the video game console 110. And communications data (e.g., messages, commands, etc.) can be exchanged between the video game console 110 and the video game player devices 130 through the video game platform 170.

In an example, the player evaluation platform 150 receives content metadata 176 for video games from the video game platform 170. Content metadata 176 may include definitions for individual and/or discrete instance of game content available within a video game. There may be one or more types of content metadata 176. The types of content metadata may correspond to the common types of content within video games, such as activities, actors, mechanics, zones, or the like, as further described above. Each type of content metadata may include one or more fields and/or attributes that are common to that particular type of content, as described further herein.

In an example, the player evaluation platform 150 receives content event definitions 174 for the content in video games from the video game platform 170. Content event definitions 174 may include definitions for individual instances of events and/or actions that can occur in relation to a corresponding instance of game content during execution of a video game. Content event definitions 174 may include one or more types of event definitions. The types of content event definitions may correspond to the common types of events and/or actions that occur within video games in relation to corresponding types of game content. Each type of content event definition may include one or more fields and/or attributes that are common to that particular type of event, as described further herein. In some embodiments, content event definitions include one or more fields and/or attributes for derived data, such as network configurations.

The video game platform 170, the player evaluation platform 150, or a combination thereof can collect data about an activity in a video game. Generally, an activity is a unit of game play inherent to the structure of a video game. Different categories of activities exist including progress activities, competitive activities, challenge activities, and open-ended activities. While described as activities, other methods of defining units of gameplay that are discrete and distinguishable within the structure of a video game are possible. The one or more fields and/or attributes in the content metadata for an activity may include an activity identifier, a name, and a category. The activity identifier is a unique identifier of the activity. Corresponding event definitions may refer to the activity identifier. The name can be a short, localized name of the activity. Other properties are possible including, for instance, a description (e.g., a longer description of the activity), an image of the activity, a default availability (e.g., whether the activity is available to all video game players before launching the video game), whether completion of the activity is required to complete the video game, whether the activity can be played repeatedly in the video game, and nested Tasks (child activities, also referred to herein as sub-activities). Multiple types of event definitions for activities are possible.

An example of an event about an activity can indicate changes in activity availability for a video game player (e.g., the user 122). This is primarily used to decide what activities to display and to remove spoiler block for those activities (where an activity having a spoiler may not be surfaced to the video game player). A property of this event may include, for instance a list (e.g., array) of activities that are currently available.

An example of an event about an activity can indicate that a video player is currently participating in the activity or task (e.g., a child activity). A property of this event may include, for instance the activity identifier of the activity. Another property can optionally be a time corresponding to the start of the participation in the activity.

An example of an event about an activity can indicate the end of the activity or task (e.g., a child activity). A property of this event may include, for instance the activity identifier of the activity. Another property can optionally be a time corresponding to the end of the participation in the activity. Yet another property can optionally be an outcome of the activity, such as completed, failed, or abandoned.

The video game platform 170, the player evaluation platform 150, or a combination thereof can also collect data about a zone in a video game. The zone may represent an area of a game world of the video game (e.g., a virtual world) with a single coordinate system. A zone may have a two-dimensional (2-D) map image associated with it, used to display locations on the zone. The one or more fields and/or attributes in the content metadata for zones may include a zone identifier and a name. The zone identifier is a unique identifier of the zone. The name can be a short localizable name of the zone. Other properties are possible including, for instance, an indication of whether the object should be treated as hidden for spoiler block uses cases (the default may be set to false), a map (e.g., a high resolution image for the zone 2-D map), a view projection (e.g., a matrix (4×4) to convert from three-dimensional (3-D) work coordinates to 2-D map position), and an image (e.g., a display image for the zone if different from the map). Multiple types of events about zones are possible.

An example of an event about a zone can indicate an update to the current in-game location of the video game player. This event can be reported regularly, or whenever the player's in-game location changes significantly. A property of this event includes the zone identifier. Other properties are possible, such as optionally position (e.g., x, y, z position of the video game player character (the virtual player of the video game player) in the zone) and orientation (e.g., x, y, z vector indicating the video game player character's direction).

Another example of an event about a zone can indicate the video game player's zone, location, and orientation, at the time of starting an activity. This event can enable location-based help. A property of this event includes the activity identifier. Other properties are possible, such as optionally the zone identifier and the position and orientation of video game player's character in the video game.

Yet another example of an event about a zone can indicate the video game player's zone, location, and orientation, at the time of ending an activity. This event can also enable location-based help. A property of this event includes the activity identifier. Other properties are possible, such as optionally the outcome of the activity, the zone identifier, and the position and orientation of video game player's character in the video game.

The video game platform 170, the player evaluation platform 150, or a combination thereof can also collect data about an actor in a video game. The actor can represent an entity with behaviors in the video game. The actor can be player-controlled or game-controlled, and this can change dynamically during game play. The one or more fields and/or attributes in the content metadata for an actor can include an actor identifier and a name. The actor identifier is a unique identifier of the actor. The name can be a localizable name of the actor. Other properties are possible including, for instance, an indication of whether the object should be treated as hidden for spoiler block uses cases (the default may be set to false), an image of the actor, and a short description of the actor. Multiple events about actors are possible.

An example of an event about actor(s) can indicate that a change to the video game player's selection of actor(s). Selected actors represent the actors the video game player is controlling in the video game, and can be displayed on the video game player's profile and other presentation spaces. There can be more than one actor selected at a time. The video game should replace the list of actors upon loading save data. A property of this event includes a list (e.g., array) of actors which are currently selected by the video game player.

The video game platform 170, the player evaluation platform 150, or a combination thereof can also collect data about a mechanic in a video game. A mechanic may represent an item (e.g., tool), capability, skill, or effect that can be used by video game players or the video game to impact game play (e.g. bow, arrow, stealth attack, fire damage). Mechanics generally exclude items that do not impact game play (e.g. collectibles). The one or more fields and/or attributes in the content metadata for a mechanic can include a mechanic identifier and a name. The mechanic identifier is a unique identifier of the mechanic. The name can be a short localizable name of the mechanic. Other properties are possible including, for instance, an indication of whether the object should be treated as hidden for spoiler block uses cases (the default may be set to false), an image of the mechanic, and a short description of the mechanic. Multiple events about mechanics are possible.

An example of an event about a mechanic can indicate that the mechanics available to a video game player have changed. Availability of a mechanic represents that the mechanic is available in the game world for the video game player to use, but may necessitate the video game player to go through some steps to acquire it into inventory (e.g. download from a store, pick up from the world) before using it. This event can also be used to indicate lifting of spoiler block on the mechanic object, and to filter help tips to avoid suggesting use of a mechanic that is unavailable. The video game should replace the list of mechanics upon loading save data. A property of this event includes a list (e.g., array) of mechanics which are currently available.

Another example of an event about a mechanic can indicate that a video game player's inventory has changed. Inventory refers to mechanics that are immediately usable to the video game player without having to take additional steps in the video game before using it. Inventory information can be used to estimate a player's readiness for an activity. The video game should replace the list of inventories upon loading save data. A property of this event includes a list (e.g., array) of mechanics which are currently in inventory.

Yet another example of an event about a mechanic can indicate that a video game player's load out has changed. Load out represents the mechanics that are most immediately accessible to the video player, and is the subset of inventory which is displayable to the video game player. The video game should replace the list of mechanics upon loading save data. A property of this event includes a list (e.g., array) of mechanics which are now part of the active load out.

A further example of an event about a mechanic can indicate that the mechanic has been used by or against a video game player. Properties of this event include a list (e.g., array) of mechanics which were used (e.g. fire arrow, fire damage) and whether the mechanics were used by or against the video game player. Other properties are possible, such as optionally an initiator actor identifier (e.g., an identifier of the actor that initiated the use of the mechanic), a zone identifier of the initiator actor, and a position of the initiator actor.

Another example of an event about a mechanic can indicate that the mechanic had an impact on game play (e.g. an arrow hit a target). Properties of this event include a list (e.g., array) of mechanics which were used (e.g. fire arrow, fire damage) and whether the mechanics were used by or against a video game player. Other properties are possible, such as optionally the initiator actor identifier, the zone identifier of the initiator actor, the position of the initiator actor, a target actor identifier (e.g., an identifier of the actor targeted by the mechanic), a zone identifier of the target, a position of the target actor, and an identifier of a mechanic that mitigates the initiator's mechanic(s).

The video game platform 170, the player evaluation platform 150, or a combination thereof can also collect data about game media in a video game. The game media may represent a piece of media (text, audio, video, image) related to the video game. Game media may be provided by the game developer as a pre-rendered piece of media and/or algorithmically generated, such as a piece of media rendered by an in-game engine. The game media may exist in-game (e.g. cut-scene, audio log, book) or may not (e.g. developer commentary). The one or more fields and/or attributes in the content metadata for a piece of game media may include a game media identifier, a name, a format, a category, an unlock rule, and a uniform resource locator (URL). The game media identifier is a unique identifier of the game media. The name can be a localizable name of the game media. The format can indicate the media format, such as whether the game media is an image, audio, video, text, etc. The category indicates a type of the game media, such as whether the game media is a cut-scene, audio-log, poster, developer commentary, etc. The unlock rule indicates whether the game media should be unlocked for all video game players or based on an activity or a specific game media event. The URL references a server-provisioned media file, where this server can be part of the video game platform 170. Other properties are possible including, for instance, an indication of whether the object should be treated as hidden for spoiler block uses cases (the default may be set to false), an entitlement (e.g., indicating that only video game players who own a particular video game entitlement can unlock the game media), and an activity identifier (e.g., to associate the game media with a particular activity). Multiple events about game media are possible.

An example of an event about game media can indicate that a particular piece of game media has been unlocked for a video game player. A property of this event includes the game media identifier.

Another example of an event about game media can indicate that a particular piece of game media has started in the video game. The game media object should be considered unlocked for the video game player at the corresponding time. A property of this event includes the game media identifier.

Yet another example of an event about game media can indicate that a particular piece of game media has ended in the video game. A property of this event includes the game media identifier.

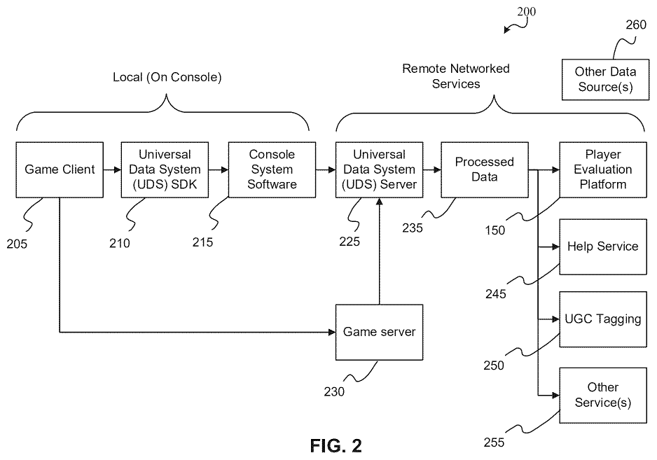

FIG. 2 illustrates an example of a system architecture 200 for providing contextual information related to a video game, according to embodiments of the present disclosure. In some embodiments, the exemplary system architecture 200 includes a game client 205, a universal data system (UDS) software development kit (SDK) 210, console system software 215, a local rule engine 220, a UDS server 225, a game server 230, processed data 235, the player evaluation platform 150, and one or more other remote networked services, including a help service 245, user generated content (UGC) tagging 250, and other service(s) 255. The help service 245 may also receive information from other data source(s) 260. Some of the components of the system architecture 200 are examples of components of the video game platform 170 of FIG. 1. For instance, the UDS server 225 and the game server 230 may be components of the video game platform 170.

The game client 205 and game server 230 provide contextual information regarding at least one application to a universal data system (UDS) server 225 via a UDS data model describing the logical structure of UDS data used by the UDS SDK 210. The UDS data model enables the platform (e.g., the video game platform 170) to realize remote networked services, such as the help service 245, UGC tagging 250, and other service(s) 255 that require game data, without requiring a game to be patched separately to support a service. The UDS data model assigns contextual information to a portion of information in a unified way across games. The contextual information from the game client 205 and UDS SDK 210 is provided to the UDS server 225 via the console system software 215. It is to be understood that the game client 205, UDS SDK 210, console system software 215, and local rule engine 220 may run on a computer or other suitable hardware for executing at least one application.

The UDS server 225 receives and stores contextual information from the game client 205 and game server 230 from at least one application. To be sure, the UDS server 225 may receive contextual information from a plurality of game clients and game servers for multiple users. The information may be uniformly processed 235 and then received by the plurality of remote networked services 245, 250, and 255. The information may further be received by the player evaluation platform 150, as described in further detail below with respect to FIGS. 3-9.

FIG. 3 illustrates an example of a system 300 for generating instructions related to a video game 340, according to embodiments of the present disclosure. The system 300 may be a distributed computing environment that includes device(s) 330 and the player evaluation platform 150. The device(s) 330 and the player evaluation platform 150 may be communicatively coupled via a network (e.g., such as the Internet or other suitable wide area network). The player evaluation platform 150 may be a server-based video game service that may, among performing other operations, receive game data and signals from the device 330 and provide instructions to the device 330

The device 330 may include one or more devices used by a user to play the video game 340. The device 330 may correspond to one or more of the video game player devices 130 (e.g., the video game controller 134), to the video game console 110, to the display device 140, or a combination thereof. Accordingly, examples of the device 330 include a video game console, a video game controller, a smart phone, a tablet, a microphone, a personal computer, a laptop, other suitable devices, or a combination thereof.

In one example, the player evaluation platform 150 may receive, from the device 330, a request for instructions related to the video game 340. In some examples, the request may be a natural language input provided by the user using a video game player device. For example, the user may speak into a microphone associated with a video game controller to provide the natural language input. In another example, the user may input text using the video game controller. In either case, the request can be received by video game console 110 and transmitted, by the video game controller 110, to the player evaluation platform 150. In other examples, the request may be transmitted by the video game controller or another video game player device.

The request may indicate an event 342 in game play of the video game 340 for which the user desires instructions. An event can occur during any segment of game play of a video game, and can involve any actor, mechanic, zone, or other characteristic of the video game with which the user comes into contact during game play of the video game. Examples of events are described above with respect to FIG. 1. Additional examples of events include a game play against a particular actor (e.g., a target opponent) in the video game 340, a game play within a particular zone of the video game 340, and a game play in which a particular mechanic of the video game 340 was used. The event 332 may span a length of time (e.g., equal to or less than 1 minute, 30 minutes, or 60 minutes).

Additionally, in some examples, the request may be a request for instructions related to improving a speed, accuracy, or type of controller inputs during the game play of the video game 340 (e.g., during the event 342). In another example, the request may be a request for instructions on how to improve at or perform a particular action, activity, or the like in the video game 340, how to navigate a zone in the video game 340, how to use a particular mechanic in the video game 340, etc. Moreover, in an example, the request may be a request for strategic information related to a game play mode, a difficulty level, or the like in the video game 340. Additionally, in an example, the request may be a request for instructions on how to improve at or train for the event 342. In one particular example, the event 342 is a game play against a target opponent (e.g., a player-controlled or game-controlled actor) in the video game 340.

In response to receiving the request, the player evaluation platform 150 can analyze the request to identify the event, the action, the zone, the mechanic, the target opponent, other aspects of the video game 340, or a combination thereof for which instructions are requested. The player evaluation platform 150 may then access game data 310 and one or more video game signals 302 related to the request. In other examples, the player evaluation platform may automatically access the game data 310 and video game signals 302 without receiving a request.

In either case, the player evaluation platform 150 may access the game data 310, which may be related to the event 342 or another aspect of the game play of the video game 340 by the user. The game data 310 may include one or more videos of the game play. In the particular example, video 312 is a video of game play of the user against the target opponent. The game data 310 may also include contextual information regarding the video game 340 (e.g., the contextual information provided by the UDS server 225 of FIG. 2). The game data 310 may further include data about a zone in the video game 340, data about an actor (e.g., the target opponent) in the video game 340, data about a mechanic in the video game 340, data about game media in the video game 340, or a combination thereof, as described above with respect to FIG. 1.

Additionally, for an event (e.g., event 342), the game data 310 may include a name of the event 342, a description of the event 342, a state of the event 342 (whether ongoing, completed unsuccessfully, or completed successfully), whether an activity (of which the event may be an instance) is required to complete an objective or campaign in the video game 340, an in-game location (e.g., a zone) for where the event 342 took place, etc.

The player evaluation platform 150 may further access video game signals 302 generated during game play of the video game 340 by the user. The video game signals 302 may be generated during events in the video game 340 (e.g., during the game play of the user against the target opponent). A video game signal may include any signal generated by a device (e.g., a video game controller, a console, or a display device) while a user is playing a video game. For example, the video game signal 302 may include controller input 304. The controller input 304 may be indicative of how various buttons, joysticks, analog sticks, directional pads, touch screens, or the like of a video game controller were used by the user during the game play of the video game 340. Thus, the controller input 304 can include data indicative of analog stick movement, push-button presses, trigger-button presses, direction pad use, or the like.

In another example, the video game signals 302 include audio input 344. For example, the user may use a microphone associated with the device 330 (e.g., associated with the video game controller 134 or the video game console 110) to provide voice commands. Thus, the audio input 344 may include the voice commands provided by the user during the game play. Additionally, or alternatively, the audio input 344 may include audio from the video game 340 during the game play. Moreover, the video game signals 302 can include chat input. The chat input can include any text input provided or received by the user during the game play (e.g., from a chat session that occurred during that game play between the user and another user or an actor associated with the video game 340).

The video game signals 302 may also include settings of the video game 340 during the game play, settings of the device 330 (e.g., a controller or another video game device) used by the user for the game play, or a combination thereof. The video game settings 306 may include any user-selected numerical or textual value for a feature of the video game 340. For example, the video game settings 306 may include a user-selected difficulty level of the video game 340 during the game play, a user-selected gameplay mode of the video game 340 during the game play, or a user-selected environment of the video game 340 during the game play. The video game settings 306 may further indicate values (e.g., a value between 1 and 100) that features of the game were set to during the game play. Similarly, the video game settings 306 may indicate whether features were enabled or disabled during the game play. Conversely, the controller settings 308 may include any user-selected setting of the device 330. In one example in which the device 330 includes a video game controller, the controller settings 308 may include a user-selected sensitivity of the video game controller during the game play or a mapping of the buttons of the controller to actions in the video game 340 during the game play.

Once, the player evaluation platform 150 receives the video game signals 302 and the game data 310, evaluation data 322 can be generated. The evaluation data 322 may be labeled with a label that defines or otherwise indicates the one or more events (e.g., event 342) associated with the game data 310 and/or the video game signals 302. For example, the evaluation data 322 may be associated with a label indicating that the evaluation data is for the game play against the target opponent. The evaluation data 322 may describe a relationship between the event 332 and inputs received in association with the event 332 (e.g., the video game signals 302). The evaluation data 322 may further provide statistics, scores, or the like and associate such statistics, scores, or the like with the inputs.

For example, the evaluation data 322 may include data indicative of a speed of the controller inputs 304 or may provide a score or other indication of the speed relative to one or more other users. In another example, the evaluation data 322 may include a time taken by the user to complete an event, level, campaign, or the like of the video game 340 or may provide a score or other indication of the time relative to one or more other users. The evaluation data 322 may additionally or alternatively include data associated with the video game signals 302. For example, the evaluation data 322 may include the controller inputs 304, the controller settings 308, the video game settings 306, etc.

The evaluation data 322 may be generated by inputting the game data 314 and the video game signal 302 into one or more AI models (e.g., AI model 318). The AI models may be trained to generate statistics, scores, instructions, or a combination thereof related to the game play of the user of the video game 340 using game data and video game signals. For example, the AI model 318 may be trained using a dataset of annotated game data and video game signals for game play of the video game (e.g., game data and video game signals annotated with scores, statistics, or the like). The AI model 318 can learn to recognize patterns and features associated with different game play of the video game 340 to determine game data, video game signals (e.g., controller inputs, controller input speed, etc.), or a combination thereof that are associated with success in the video game 340. For example, the AI model 318 may be able to identify a mechanic associated with a high likelihood of defeating a boss, level, or the like of the video game. In another example, the AI model 318 can identify a set of controller inputs associated with a high likelihood of defeating the boss, level, or the like. The AI model 318 can further learn to recognize patterns and features associated with the game play of more than one video game (e.g., video games within a same or similar genre as the video game 340).

The one or more AI models (e.g., AI model 318) can also be continuously updated and refined by incorporating new data from additional events and game play for one or more video game, thereby improving the accuracy and adaptability of the AI models over time. This allows the AI models to stay current with evolving game development practices and new types of game content and events. The system 300 may further incorporate a feedback loop that retrains the AI models based on the manual verifications and/or modifications. This can ensure that the generated metadata and label for the video 316 accurately reflects the intended game design and logic of the video game 320.

In an example, the player evaluation platform 150 includes the AI model 318 trained to generate, for the video game signal 302 and the game data 310, the evaluation data 322. For example, the AI model 318 may analyze the game data 314 (e.g., the video 316) and the video game signal 302 to identify the statistics, scores, instructions, or other suitable data reflecting an assessment of the game play of the user. To do so, the AI model 318 might look for specific patterns in the game data 314 that indicate the event 342 associated with the game play (e.g., that the user is playing against the target opponent). The AI model 318 may then generate the evaluation data 322 based on the event. For instance, if the identified event includes game play against the target opponent, the AI model 318 may generate evaluation data 322 describing the boss battle (e.g., a time the battle took, a winner of the battle, etc.), describing the video game signals 302 obtained during the boss battle (e.g., a speed of controller inputs), with instructions for improving against the boss (e.g., alternate control inputs or settings for the video game), other evaluation data, or a combination thereof.

The AI model 318 can represent the evaluation data 322 in its latent space in some examples. Alternatively, the evaluation data 322 can be stored separately as plain text. As shown in FIG. 3, the evaluation data 322 may be transmitted to a data store 324 for storage. The data store 324 may store the evaluation data in a structured manner. For example, the evaluation data 322 be grouped with other evaluation data for the event in the video game, for the video game, or for similar video games (e.g., video games of the same or similar genre as video game 320).

The player evaluation platform 150 can further generate the instructions 326. The instructions 326 may be output by the AI model 318 in accordance with the evaluation data 322 in some examples. For example, in generating the evaluation data 322 the AI model 318 can, based on previously learned patterns, determine the instructions 326 for improving one or more aspects of the game play of the user. As a result, the instructions 326 may be output based on and with the evaluation data 322.

The instructions 326 may be for controlling a video game player device (e.g., a video game controller). That is, the instructions may involve a suggestion of any action that can be performed in the video game by the user using a video game player device (e.g., a video game controller). For example, the instructions 326 may suggest moving an actor, selecting a mechanic, selecting video game settings, etc. Alternatively, the instructions may be suggestion of a controller input that the user can provide via the video game controller to cause an action in the video game. For example, the instructions 326 may suggest that a user move an analog stick, press a push-button, press a trigger-button, use a directional pad, or otherwise indicate to the user how to interact with or control a video game controller or other video game player device.

In some examples, the instructions 326 may, in addition or alternative to the above, include a video game signal recommendation 338. The video game signal recommendation 338 may be based on the controller input 304, controller settings 308, or video game settings 306 received by the player evaluation platform 150 and input into the AI model 318 as part of the video game signals 302. Accordingly, the video game signal recommendation 338 may be a recommendation to change the controller input 304, the controller settings 308, or the video game settings 306. The video game signal recommendation 338 may further be a recommendation to execute an alternate controller input, controller setting, or video game setting. For example, the video game signal recommendation 338 may include an alternative controller input. As an example, the alternative controller input can indicate to the user that pressing a set of buttons in a particular order will facilitate an action that will help in the event 342. In another example, the video game signal recommendation 338 can include an alternative setting for the video game controller. For example, the video game signal recommendation 338 may be a recommendation that a sensitivity setting of the controller be increased. Moreover, the video game signal recommendation 338 can include an alternative setting for the video game. For example, the video game signal recommendation 338 may be a recommendation that a first feature be disabled in the video game settings 306 and a second feature be enabled in the video game settings 306.

The instructions 326 (e.g., video game signal recommendation 338, the suggestion to perform an action in the video game, the suggestion to provide a controller input, etc.) may, in some examples, by provided in real time. For example, the instructions 326 may be provided during the event 342 in the video game 340 (e.g., during game play of the user against the target opponent). In other examples, the instructions 326 may be provided after the event 342, while the video game 340 is paused, or between events, levels, or the like of the video game 340.

In either case, the instructions 326 may be received and interpreted by the console 110. The console 110 may then cause the instructions to be output via the display device 140 or a video game player device. Moreover, the instructions 326 may include an aural instruction signal 328, a visual instruction signal 334, or a combination thereof. The aural instruction signal 328 may involve providing the instructions 326 to the user with audio. For example, the instructions 326 may be output as audio via the video game controller 134, the display device 140, or another video game player device. Conversely, the visual instruction signal 334 may be a visual overlay displayed on a display device associated with the video game 340 (e.g., display device 140). The visual overlay may be displayed with video game content associated with the video game 340. For example, the visual instruction signal 334 may involve text output via the display device 140. In another example, the visual instruction signal 334 may bean indicator (e.g., arrows, images, etc.) output via the display device 140 to help the user (e.g., by pointing the user in a direction or helping the user to aim).

Additionally, in some examples, the player evaluation platform 150 may generate a review video 336 of the event 342 (e.g., of the game play of the user against the target opponent). The review video 336 may include the video 312 of the event 342. The player evaluation platform 150 may further add the instructions 326 to the video. For example, one or more aural instruction signals (e.g., audio indicative of the instructions 326), one or more visual instruction signals (e.g., text, images, or other visual indicators of the instructions 326), or a combination thereof can be added to the video 312 when generating the review video 336. Thus, the review video 336 can provide a way for the user to review the game play associated with the event 342 and the instructions 326.

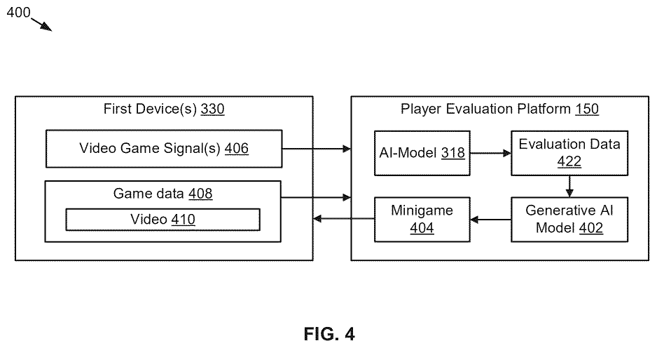

FIG. 4 illustrates an example of a system 400 for generating a minigame 404 related to the video game 340, according to embodiments of the present disclosure. Similar to the above, the system 400 may be a distributed computing environment that includes the device(s) 330 and the player evaluation platform 150.

The minigame 404 may be generated by inputting the evaluation data 322, the video game signals 302, the game data 310, or a combination thereof into a generative AI model 402. The minigame 404 may be related to the event 342. For example, the minigame 404 may be a practice match against the target opponent. In another example, the minigame 404 may be generated to facilitate practice of a skill, activity, or the like associated with the event 342. For example, the minigame 404 may be a shooting game intended to improve aim.

The player evaluation platform 150 may include the generative AI model 402 trained to identify instances of game content, as well as the events that may occur in relation to the instances of game content and generate the corresponding minigames. For example, the generative AI model 402 may be trained using a dataset of annotated evaluation data, game data, video game signals, other data related to the video game 340, or a combination thereof. As a result, the generative AI model 402 can learn to recognize patterns and features associated with different types of game content and events. For example, the generative AI model 402 may be able to identify an actor object by recognizing images in the video 312 of the game data 310 and generate a minigame 404 with the actor. Additionally, the generative AI model 402 may be able to identify, based on the evaluation data 322, that the user has been unable to beat the actor. Thus, the generative AI model 402 can generate the minigame 404 with the actor based on the indication in the evaluation data that the user has not been able to beat the actor.

The generative AI model 402 can be continuously updated and refined by incorporating new data from additional games, thereby improving accuracy and adaptability of the generative AI model 402 over time. This allows the player evaluation platform 150 to stay current with evolving game development practices and new types of game content and events.

After generating the minigame 404, the player evaluation platform 150 can transmit the minigame 404 to the device 330 to enable the user to play the minigame. In an example, the player evaluation platform 150 may transmit the minigame 404 to a video game console 110 by transmitting video game software (e.g., program code) for the minigame 404 to the video game console 110. The video game console 110 may then execute the video game software for the minigame 404 to display video game content of the minigame 404 via the display device 140 and to enable the user to play the minigame using the video game controller 134. In this way, the user may be able to prepare for a subsequent game play of the event 342 or a similar event. For example, the minigame 404 may help the user to prepare for a subsequent game play against the target opponent.

Additionally, in some examples, the player evaluation platform 150 performs continuous analysis of the game play by the user to update the evaluation data 322, the minigame 404, or the combination thereof accordingly. To do so, the player evaluation platform 150 may access second game data 408, which may include another video 410 depicting a game play of the user of the minigame. The player evaluation platform 150 may further access second video game signals 406 generated during the game play of the minigame by the user. The second game data 408 and second video game signals 406 may then be input into the AI model 318 to generate second evaluation data 422, updated instructions, or a combination thereof for the game play of the user in the minigame. The second evaluation data 422 may then be input into the generative AI model 402 to generate a second minigame for facilitating additional practice for the event 342. The second minigame may be associated with a higher level of difficulty than the first minigame.

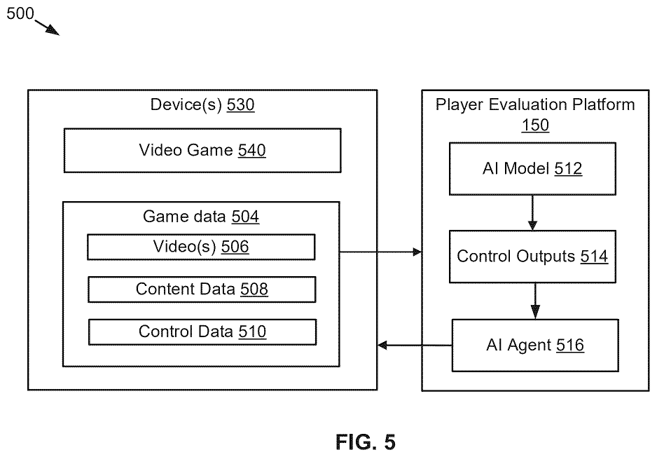

FIG. 5 illustrates an example of a system for executing an AI agent in a video game 540, according to embodiments of the present disclosure. The system 500 may be a distributed computing environment that includes device(s) 530 and the player evaluation platform 150. The device(s) 530 and the player evaluation platform 150 may be communicatively coupled via a network (e.g., such as the Internet or other suitable wide area network).

The device 530 may include one or more devices used by a user to play a video game 540. The device 530 may correspond to one or more of the video game player devices 130 (e.g., the video game controller 134), to the video game console 110, the display device 140, or a combination thereof. Accordingly, examples of the device 530 include a video game console, a video game controller, a smart phone, a tablet, a microphone, a personal computer, a laptop, other suitable devices, or a combination thereof.

The player evaluation platform 150 may receive game data 504 related to the video game 540. The game data 504 can include videos 506 of game play of the video game 540. The game data 504 may also include content data 508. The content data 508 may include the content metadata 176, the content event definitions 174, or a combination thereof as described above with respect to FIG. 1. The content data 508 may further include contextual information regarding the video game 540 (e.g., the contextual information provided by the UDS server 225 of FIG. 2). The game data 504 may further include data about zones in the video game, data about actors in the video game, data about mechanics in the video game, data about game media in the video game, or a combination thereof, as described above with respect to FIG. 1. Moreover, the game data 504 can include control data 510 related to how various actors, mechanics, etc. are controlled in the video game 540.

The game data 504 can be input into one or more AI models (e.g., AI model 512). The AI models may be trained to generate control outputs related to the game play of an AI agent of the video game 340 using game data. For example, the AI model 512 may be trained using a dataset of annotated game data (e.g., game data annotated with control outputs). As a result, the AI model 512 can learn to recognize patterns and features associated with different game play of the video game 540 to determine control outputs for an AI agent. The control outputs can be actions that the AI agent will perform in the video game. For example, the AI model 512 may be able to generate control outputs that cause an AI agent to defeat a boss, level, or the like of the video game.

The one or more AI models (e.g., AI model 512) can also be continuously updated and refined by incorporating new data from additional events and game play for one or more video game, thereby improving the accuracy and adaptability of the AI models over time. This allows the AI models to stay current with evolving game development practices and new types of game content and events. The AI model 512 can further learn to recognize patterns and features and generate control outputs for more than one video game (e.g., video games within a same or similar genre as the video game 540).

In an example, the player evaluation platform 150 may receive, from the device 530, a request for an AI agent 516 for the video game 540. The request may indicate characteristics of the AI agent 516. For example, the request may indicate a role for the AI agent 516. The role may indicate the actor (e.g., character) in the video game 540 that the AI agent will be. The request may further indicate a style of play for the AI agent.

Upon receiving the request, the player evaluation platform 150 can generate control outputs 514 for the AI agent 516 using the AI model 512. In one example, the AI model 512 may be trained using the game data 504. In such an example, the request or information associated with the request (e.g., the role of the AI agent) may be input into the AI model 512. Alternatively, in response to the request, the game data 504 may be input into the AI model 512. In either case, the AI model 512 can generate the control outputs 514 based on the game data 504. The control outputs may be actions for the AI agent 516 to perform in the video game 540, audio for the AI agent 516 to appear to speak in the video game 540, or the like.

The player evaluation platform 150 may then execute, on the device 530, the AI agent 516 using the control outputs 514 in the video game 540. As a result, the AI agent 516 can participate in game play of the video game 540 with the user. The AI model 512 may continuously receive game data during the game play of the video game 540 with the user and the AI agent 516. Consequently, the AI model 512 can output control outputs continuously during the game play. This, in turn, enables the AI agent 516 to be executed through out the game play of the video game 540. This further enables the actions of the AI agent 516 to be aligned with real-time events within the video game 540.

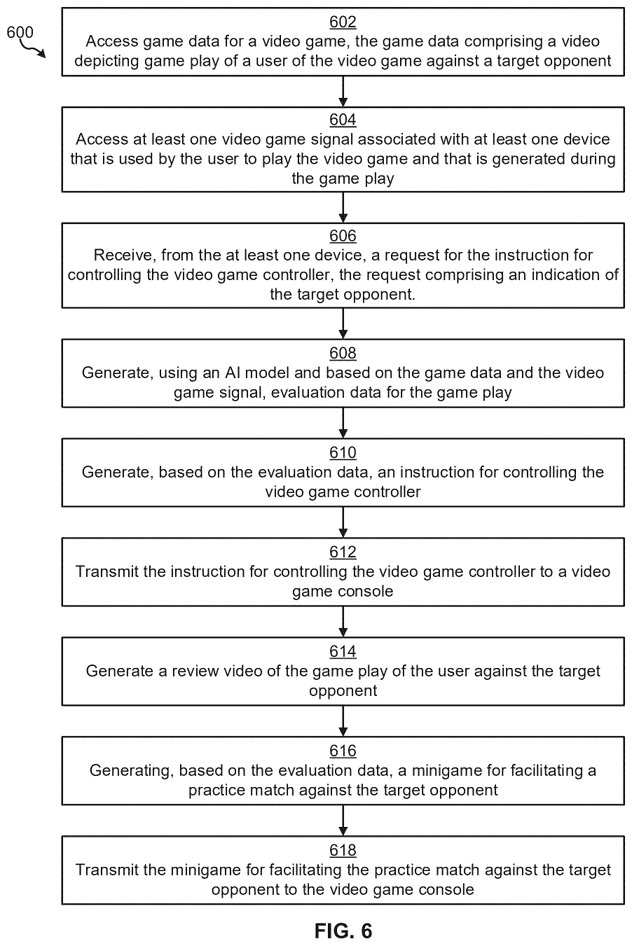

FIG. 6 is a flow chart of an example of a method 600 for generating at least one of an instruction for controlling a video game controller and a minigame related to a video game, according to embodiments of the present disclosure. The steps of the method 600 can be implemented as hardware circuitry and/or stored as computer-readable instructions on a non-transitory computer-readable medium of a computer system, such as a video game console and/or a video game platform. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is required and that certain operations can be omitted. The steps of FIG. 6 are described below with reference to components discussed above with respect to FIGS. 1-4 and 8.

At block 602, the method 600 involves accessing game data for a video game. The game data may include a video depicting game play of a user of the video game against a target opponent (e.g., a player-controlled or game-controlled actor) of the video game. In an example, the target opponent is a second user of the video game. Thus, in the example, the target opponent is a player-controller actor.

At block 604, the method 600 involves accessing at least one video game signals associated with at least one device that is used by the user to play the video game. The at least one device may include a video game controller, a video game console, a display device, other video game player devices, or a combination thereof. The video game signals may be generated by the devices during the game play of the user of the video game. The video game signals may include a set of controller inputs detected during the game play, settings of a controller used by the user during the game play, or a combination thereof. Such video game signals may be generated via a video game controller that the user uses during the game play of the video game. Additionally, the video game signals may include settings of the video game during the game play, audio inputs provided by the user during the game play, chat inputs provided by the user during the game play, or a combination thereof. These video game signals may be generated via the video game controller or may be generated by other devices that may be used during the game play of the user of the video game (e.g., a video game console or a display device).

At block 606, the method 600 involves receiving, from the at least one device, a request for the instruction for controlling the video game controller, the request comprising an indication of the target opponent. The request may be a natural language input provided by the user using the device. For example, the user may speak into a microphone associated with a video game controller to provide the natural language input. In another example, the user may input text using the video game controller. The natural language input may then be received by video game console. Additionally, in the example, the request may be a request for instructions on how to improve at game play against the target opponent in the video game.

At block 608, the method 600 involves generating, using an AI model and based on the game data and the video game signal, evaluation data for the game play. The evaluation data 322 may be labeled with a label that defines or otherwise indicates an event associated with the game data and/or the video game signals. For example, the evaluation data may be associated with a label indicating that the evaluation data is for the game play against the target opponent. The evaluation data may describe a relationship between the game play against the target opponent and the video game signals. The evaluation data 322 may further provide statistics, scores, or the like and associate such statistics, scores, or the like with the inputs. For example, the evaluation data may include data indicative of a speed of the controller inputs.

As mentioned above, in the example, the target opponent is a player-controller actor. Accordingly, in the example, the method may further involve accessing second game data that includes a second video depicting a game play of the video game by the second user. Additional video game signals associated with devices that are used by the second user to play the video game and that are generated during the second game play may also be accessed. The AI model may then be trained, at least in part, using the second video game signal and the second game data. In this way, the evaluation data generated can be reflective of how well the user played the video game relative to the second user.

At block 610, the method 600 involves generating, based on the evaluation data, an instruction for controlling the video game controller. The instruction may be a suggestion of controller inputs, controller settings, video game settings, or the like to help the user in the game play against the target opponent (e.g., the second user). Additionally or alternatively, the instructions may involve a suggestion of one or more actions that can be performed in the video game by the user using the a video game controller. For example, the instructions 326 may suggest moving an actor controlled by the user in a particular direction or selecting a mechanic to use in the match against the target opponent.

At block 612, the method 600 involves transmitting the instruction for controlling the video game controller to the at least one device (e.g., to a video game console). The instructions 326 may be received as code that can be interpreted and executed by the console. As a result, the console 110 may cause the instructions to be output via the display device or a video game player device. The instructions may include an aural instruction signal, a visual instruction signal 334, or a combination thereof. The aural instruction signal may involve providing the instructions to the user with audio. Conversely, the visual instruction signal may be a visual overlay displayed on the display device. The visual instruction signal may involve text output via the display device or an indicator (e.g., arrows, images, etc.) output via the display device.

At block 614, the method 600 involves generating a review video of the game play of the user against the target opponent. The review video may include the video depicting the game play of the user of the video game against the target opponent. The review video may further include the instruction. For example, one or more aural instruction signals (e.g., audio indicative of the instructions), one or more visual instruction signals (e.g., text, images, or other visual indicators of the instructions), or a combination thereof can be added to the video when generating the review video. Thus, the review video 336 can provide a way for the user to watch the game play against the target opponent and the instructions.

At block 616, the method 600 involves generating, based on the evaluation data, a minigame for facilitating a practice match against the target opponent. The minigame may be generated by inputting the evaluation data, the video game signals, the game data, or a combination thereof into a generative AI model. In the example in which the target opponent is a user-controlled actor, the generative AI model can generate the practice match with a game-controlled actor that is similar to the target opponent. To do so, the generative AI model may further receive the second game data and the additional video game signals and use the second game and the additional video game signals to generate the minigame.

At block 618, the method 600 involves transmitting the minigame for facilitating the practice match against the target opponent to the at least one device (e.g., to the video game console). The minigame 404 may be transmitted to the video game console by video game software (e.g., program code) for the minigame being transmitted to the video game console. The video game console may then execute the video game software for the minigame to display video game content of the minigame via the display device 140 and to enable the user to play the minigame using the video game controller 134. As a result, the user can play the minigame via the at least one device which can help the user to prepare for a subsequent game play against the target opponent.

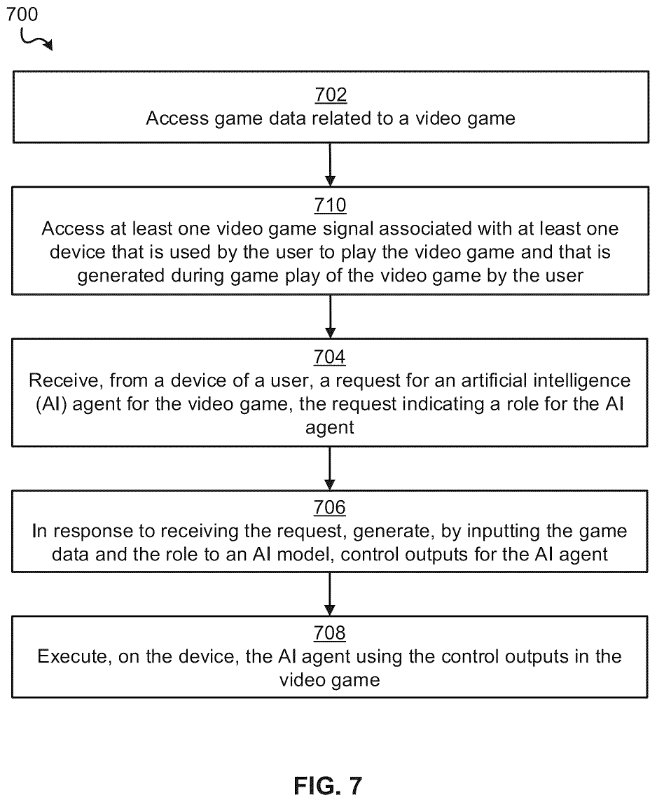

FIG. 7 is a flow chart of an example of a method for executing an AI agent in a video game, according to embodiments of the present disclosure. The steps of the method 700 can be implemented as hardware circuitry and/or stored as computer-readable instructions on a non-transitory computer-readable medium of a computer system, such as a video game console and/or a video game platform. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is required and that certain operations can be omitted. The steps of FIG. 7 are described below with reference to components discussed above with respect to FIGS. 1-3, 5, and 8.

At block 702, the method 700 involves accessing game data related to a video game. The game data can include videos of game play of the video game. The game data may also include content data. The content data may include the content metadata 176, the content event definitions 174, or a combination thereof as described above with respect to FIG. 1. The content data may further include contextual information regarding the video game (e.g., the contextual information provided by the UDS server 225 of FIG. 2). The game data may further include data about zones in the video game, data about actors in the video game, data about mechanics in the video game, data about game media in the video game, or a combination thereof, as described above with respect to FIG. 1. Moreover, the game data can include control data related to how various actors, mechanics, etc. are controlled in the video game. For example, the control data can indicate skills, actions, dialogue, etc. of actors in the video game. In another example, the control data can indicate how a mechanic is accessed and used in the video game.

At block 704, the method 700 involves accessing video game signals associated with at least one device used by the user to play the video game and that is generated during game play of the video game by the user. The at least one device may include a video game controller, a video game device, a display device, or a combination thereof. A video game signal may include any signal generated by such devices while a user is playing a video game. For example, the video game signal may include controller input. The controller input may be indicative of how various buttons, joysticks, analog sticks, directional pads, touch screens, or the like of a video game controller were used by the user during the game play of the video game. In another example, the video game signals include audio input. The audio input may include the voice commands provided by the user during the game play of the video game. Additionally, or alternatively, the audio input may include audio from the video game during the game play. Moreover, the video game signals can include chat input. The chat input can include any text input provided or received by the user during the game play.

The video game signals may also include settings of the video game during the game play, settings of the device (e.g., the video game controller or another video game device) used by the user for the game play, or a combination thereof. The video game settings may include any user-selected numerical or textual value for a feature of the video game. For example, the video game settings may include a user-selected difficulty level of the video game during the game play, a user-selected gameplay mode of the video game during the game play, or a user-selected environment of the video game during the game play. The video game settings may further indicate values (e.g., a value between 1 and 100) that features of the game were set to during the game play. Similarly, the video game settings may indicate whether features were enabled or disabled during the game play. Conversely, the controller settings may include any user-selected setting of the device. In one example in which the device includes a video game controller, the controller settings may include a user-selected sensitivity of the video game controller during the game play or a mapping of the buttons of the controller to actions in the video game during the game play.

At block 706, the method 700 involves receiving, from a device of a user, a request for an artificial intelligence (AI) agent for the video game, the request indicating a role for the AI agent. The role may indicate the actor (e.g., character) in the video game that the AI agent will be. The request may also indicate a game play mode of the video game, a zone of the video game, a level of the video game, or other characteristics of the video game. This information may enable the AI agent to be tailored to the characteristics of the video game for which the AI agent is desired. The request may further indicate a style of play for the AI agent. For example, the user may request that the AI agent play aggressively, or the user may request that the AI agent play submissively (e.g., in a manner in which the AI agent may only attack another actor if the actor of the user is threatened). The request can further indicate a skill level for the AI agent. For example, the user may request a highly skilled AI agent or a moderately skilled AI agent. In this way, the AI agent can be customized based on the skill level of the user or based on a game mode or level of the video game in which the user is playing.

At block 708, the method 700 involves, in response to receiving the request, generating, by inputting the game data and the role to an AI model, control outputs for the AI agent. The control outputs may be actions for the AI agent to perform in the video game, audio for the AI agent to appear to speak in the video game, or the like. The AI models may be trained to generate control outputs related to the game play of the video game using game data, the video game signals, or a combination thereof. For example, the AI model may be trained using a dataset of annotated game data (e.g., game data annotated with control outputs). As a result, the AI model can learn to recognize patterns and features associated with game play of the video game to determine control outputs for an AI agent. For example, the AI model may be able to generate control outputs that cause an AI agent to move through a zone in the video game.

At block 710, the method 700 involves executing, on the device, the AI agent using the control outputs in the video game. As a result, the AI agent can participate in the game play of the video game with the user in the video. The AI model may further continuously receive game data during the game play of the video game with the user and the AI agent. Consequently, the AI model can output control outputs continuously during the game play. This, in turn, enables the AI agent 516 to be executed throughout the game play of the video game. This further enables the actions of the AI agent 516 to be aligned with real-time events within the video game.

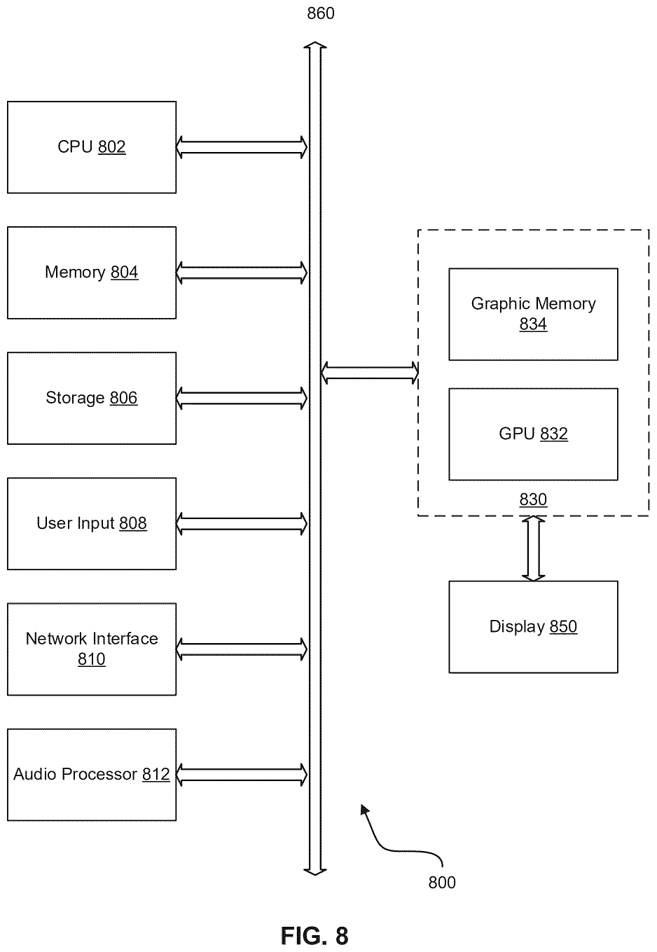

FIG. 8 illustrates an example of a hardware system suitable for implementing a computer system 800, according to embodiments of the present disclosure. The computer system 800 represents, for example, a video game console, a video game platform, a player evaluation platform, a video game controller, or other types of a computer system. The computer system 800 includes a central processing unit (CPU) 802 for running software applications and optionally an operating system. The CPU 802 may be made up of one or more homogeneous or heterogeneous processing cores. Memory 804 stores applications and data for use by the CPU 802. Storage 806 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 808 communicate user inputs from one or more users to the computer system 800, examples of which may include keyboards, mice, joysticks, touch pads, touch screens, still or video cameras, and/or microphones. Network interface 810 allows the computer system 800 to communicate with other computer systems via an electronic communications network, and may include wired or wireless communication over local area networks and wide area networks such as the Internet. An audio processor 812 is adapted to generate analog or digital audio output from instructions and/or data provided by the CPU 802, memory 804, and/or storage 806. The components of computer system 800, including the CPU 802, memory 804, data storage 806, user input devices 808, network interface 810, and audio processor 812 are connected via one or more data buses 860.

A graphics subsystem 830 is further connected with the data bus 860 and the components of the computer system 800. The graphics subsystem 830 includes a graphics processing unit (GPU) 832 and graphics memory 834. The graphics memory 834 includes a display memory (e.g., a frame buffer) used for storing pixel data for each pixel of an output image. The graphics memory 834 can be integrated in the same device as the GPU 832, connected as a separate device with the GPU 832, and/or implemented within the memory 804. Pixel data can be provided to the graphics memory 834 directly from the CPU 802. Alternatively, the CPU 802 provides the GPU 832 with data and/or instructions defining the desired output images, from which the GPU 832 generates the pixel data of one or more output images. The data and/or instructions defining the desired output images can be stored in the memory 804 and/or graphics memory 834. In embodiments, the GPU 832 includes 3D rendering capabilities for generating pixel data for output images from instructions and data defining the geometry, lighting, shading, texturing, motion, and/or camera parameters for a scene. The GPU 832 can further include one or more programmable execution units capable of executing shader programs.

The graphics subsystem 830 periodically outputs pixel data for an image from the graphics memory 834 to be displayed on the display device 850. The display device 850 can be any device capable of displaying visual information in response to a signal from the computer system 800, including CRT, LCD, plasma, and OLED displays. The computer system 800 can provide the display device 850 with an analog or digital signal.

In accordance with various embodiments, the CPU 802 is one or more general-purpose microprocessors having one or more processing cores. Further embodiments can be implemented using one or more CPUs 802 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a method which is depicted as a flow diagram or block diagram. Although each may describe the operations as a sequential process, many of the operations can be performed in parallel or concurrently. In addition, the order of the operations may be rearranged. A method may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 66%, 155%, 80%, 90%, 95%, 99%, 99.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
accessing game data for a video game, the game data comprising video depicting game play of a user of the video game against a target opponent of the video game;
accessing at least one video game signal associated with at least one device that is used by the user to play the video game and that is generated during the game play, the at least one device comprising a video game controller;
generating, using an AI model and based on the game data and the at least one video game signal, evaluation data for the game play; and
generating, based on the evaluation data, at least one of an instruction for controlling the video game controller and a minigame for facilitating a practice match against the target opponent.

2. The computer-implemented method of claim 1, wherein the at least one video game signal comprises one or more of: a set of controller inputs, settings of the video game controller that were used by the user during the game play, and settings of the video game during the game play.

3. The computer-implemented method of claim 2, further comprising:
generating, based on the evaluation data, the instruction for controlling the video game controller, wherein the instruction comprises at least one of an alternative controller input, an alternative setting of the video game controller, and an alternative setting of the video game.

4. The computer-implemented method of claim 1, wherein the at least one device further comprises a video game console and a display device, and wherein the computer-implemented method further comprises:
generating, based on the evaluation data, the instruction for controlling the video game controller; and
transmitting the instruction for controlling the video game controller to the video game console to cause the video game console to output the instruction for controlling the video game controller via the display device, wherein the instruction for controlling the video game controller is output during game play of the user against target opponent, and wherein the instruction for controller the video game controller comprises an aural instruction signal or a visual instruction signal.

5. The computer-implemented method of claim 1, further comprising:
generating, based on the evaluation data, the instruction for controlling the video game controller; and
generating a review video of the game play of the user against the target opponent, the review video comprising the video depicting the game play and the instruction for controlling the video game controller.

6. The computer-implemented method of claim 1, wherein the at least one device further comprises a video game console, and wherein the computer-implemented method further comprises:
generating, by inputting the evaluation data into a second AI model, the minigame for facilitating the practice match against the target opponent, the second AI model being a generative AI model; and
transmitting the minigame for facilitating the practice match against the target opponent to the video game console to enable a game play of the user of the minigame.

7. The computer-implemented method of claim 6, wherein the game data for the video game is first game data, the video depicting the game play of the user of the video game is a first video, and the instruction for controlling the video game controller is a first instruction, and wherein the computer-implemented method further comprises:
accessing second game data comprising a second video depicting the game play of the user of the minigame;
accessing at least one additional video game signal associated with at least one device that is used by the user to play the minigame and that is generated during the second game play;
generating, by inputting the at least one additional video game signal and the second game data into the AI model, evaluation data for the game play of the user of the minigame; and
generating, based on the evaluation data for the game play of the user of the minigame, at least one of a second instruction signal for controlling the video game controller and a minigame for facilitating an additional practice match against the target opponent.

8. The computer-implemented method of claim 1, further comprising:
prior to generating the evaluation data, receiving, from the at least one device, a request for the instruction for controlling the video game controller, the request comprising an indication of the target opponent.

9. A system comprising:
one or more processors; and
one or more memories storing instructions that, upon execution by the one or more processors, configure the system to perform operations comprising:
accessing game data for a video game, the game data comprising video depicting game play of a user of the video game against a target opponent of the video game;
accessing at least one video game signal associated with at least one device that is used by the user to play the video game and that is generated during the game play, the at least one device comprising a video game controller;
generating, using an AI model and based on the game data and the at least one video game signal, evaluation data for the game play; and
generating, based on the evaluation data, at least one of an instruction for controlling the video game controller and a minigame for facilitating a practice match against the target opponent.

10. The system of claim 9, wherein the at least one video game signal comprises one or more of: a set of controller inputs, settings of the video game controller that were used by the user during the game play, and settings of the video game during the game play.

11. The system of claim 10, wherein the operations further comprise:
generating, based on the evaluation data, the instruction for controlling the video game controller, wherein the instruction comprises at least one of an alternative controller input, an alternative setting of the video game controller, and an alternative setting of the video game.

12. The system of claim 9, wherein the at least one device further comprises a video game console and a display device, and wherein the operations further comprise:
generating, based on the evaluation data, the instruction for controlling the video game controller; and
transmitting the instruction for controlling the video game controller to the video game console to cause the video game console to output the instruction for controlling the video game controller via the display device, wherein the instruction for controlling the video game controller is output during game play of the user against target opponent, and wherein the instruction for controller the video game controller comprises an aural instruction signal or a visual instruction signal.

13. The system of claim 9, wherein the operations further comprise:
generating, based on the evaluation data, the instruction for controlling the video game controller; and
generating a review video of the game play of the user against the target opponent, the review video comprising the video depicting the game play and the instruction for controlling the video game controller.

14. The system of claim 9, wherein the at least one device further comprises a video game console, and wherein the operations further comprise:
generating, by inputting the evaluation data into a second AI model, the minigame for facilitating the practice match against the target opponent, the second AI model being a generative AI model; and
transmitting the minigame for facilitating the practice match against the target opponent to the video game console to enable a game play of the user of the minigame.

15. The system of claim 14, wherein the game data for the video game is first game data, the video depicting the game play of the user of the video game is a first video, and the instruction for controlling the video game controller is a first instruction, and wherein the operations further comprise:
accessing second game data comprising a second video depicting the game play of the user of the minigame;
accessing at least one additional video game signal associated with at least one device that is used by the user to play the minigame and that is generated during the second game play;
generating, by inputting the at least one additional video game signal and the second game data into the AI model, evaluation data for the game play of the user of the minigame; and
generating, based on the evaluation data for the game play of the user of the minigame, at least one of a second instruction signal for controlling the video game controller and a minigame for facilitating an additional practice match against the target opponent.

16. One or more computer-readable storage media storing instructions that, upon execution by one or more processors, cause operations comprising:
accessing game data for a video game, the game data comprising video depicting game play of a user of the video game against a target opponent of the video game;
accessing at least one video game signal associated with at least one device that is used by the user to play the video game and that is generated during the game play, the at least one device comprising a video game controller;
generating, using an AI model and based on the game data and the at least one video game signal, evaluation data for the game play; and
generating, based on the evaluation data, at least one of an instruction for controlling the video game controller and a minigame for facilitating a practice match against the target opponent.

17. The one or more computer-readable storage media of claim 16, wherein the at least one video game signal comprises one or more of: a set of controller inputs, settings of the video game controller that were used by the user during the game play, and settings of the video game during the game play.

18. The one or more computer-readable storage media of claim 17, wherein the instruction comprises a video game signal recommendation, the video game signal recommendation comprising at least one of: an alternative controller input, an alternative setting of the video game controller, or an alternative setting of the video game.

19. The one or more computer-readable storage media of claim 16, wherein the operations further comprise:
generating, based on the evaluation data, the instruction for controlling the video game controller, wherein the instruction comprises at least one of an alternative controller input, an alternative setting of the video game controller, and an alternative setting of the video game.

20. The one or more computer-readable storage media of claim 16, wherein the at least one device further comprises a video game console and a display device, and wherein the operations further comprise:
generating, based on the evaluation data, the instruction for controlling the video game controller; and
transmitting the instruction for controlling the video game controller to the video game console to cause the video game console to output the instruction for controlling the video game controller via the display device, wherein the instruction for controlling the video game controller is output during game play of the user against target opponent, and wherein the instruction for controller the video game controller comprises an aural instruction signal or a visual instruction signal.
